(19) United States
(12) Patent Application Publication
(10) Pub. No.: US 2024/0332750 A1
(43) Pub. Date: Oct. 3, 2024

(54) BUSBAR, ENERGY STORAGE SYSTEM COMPRISING A BUSBAR

(71) Applicant: Carl Freudenberg KG, Weinheim (DE)

(72) Inventors: Armin Striefler, Oehringen (DE); Peter Kritzer, Forst (DE)

(21) Appl. No.: 18/621,663

(22) Filed: Mar. 29, 2024

(30) Foreign Application Priority Data
Apr. 3, 2023 (DE) 10 2023 108 408.9

(51) Int. Cl. H01M 50/526; H01M 10/653; H01M 50/209; H01M 50/505

(52) U.S. Cl. CPC H01M 50/526; H01M 10/653; H01M 50/209; H01M 50/505

(57) ABSTRACT

A busbar, including an electrically conductive connector and an electrically insulating coating, wherein the connector of the busbar includes at least two connection regions connected by a bridge and wherein the coating surrounds the bridge. The coating is formed of a plastic material and the coating is formed as a molded part.

### CROSS REFERENCE TO RELATED APPLICATIONS

This application claims benefit to German Patent Application No. DE 10 2023 108 408.9, filed on Apr. 3, 2023, which is hereby incorporated by reference herein.

### FIELD

The invention relates to a busbar and an energy storage system, which is equipped with at least one such busbar.

### BACKGROUND

Busbars are components in an energy storage system, which connect individual battery cells with each other within the energy storage system. Furthermore, busbars are used for connecting a plurality of energy storage systems or for connection with other systems and components, such as the power electronics or switching elements.

Energy storage systems, in particular rechargeable storage batteries for electrical energy, are widely used, in particular, in mobile systems. Rechargeable storage batteries for electrical energy are used, for example, in portable electronic devices, such as smartphones or laptop computers. Furthermore, rechargeable storage batteries for electrical energy are being more widely used for the provision of energy for electrically powered vehicles. A great variety of electrically powered vehicles is conceivable, such as two-wheel vehicles, small vans or trucks as well as passenger vehicles. Applications in robots, on ships, aircraft and mobile working machines are also conceivable. Further fields of usage of electric energy storage systems are stationary applications, for example in backup systems, in network stabilizing systems and for the storage of electrical energy from renewable energy sources.

A frequently used energy storage system is a rechargeable storage battery in the form of a lithium-ion battery. Lithium-ion batteries, like other rechargeable storage batteries for electrical energy, mostly include a plurality of battery cells commonly installed in a housing. A plurality of electrically connected battery cells are most commonly combined in a module.

The energy storage system does not only apply to lithium-ion batteries. Other rechargeable energy storage systems, such as lithium-sulfur batteries, solid-state batteries, sodium-ion batteries or metal-air batteries are also conceivable energy storage systems. Furthermore, supercapacitors are also possible energy storage systems.

In automotive and industrial applications, there is usually a requirement that the energy storage systems need to be quickly recharged. To be able to implement this fast-charging feature without the electric wiring becoming substantially more voluminous and heavy, the system voltages of the energy storage system are usually chosen to be high. The system voltage of most current battery-electric vehicles is thus 400 V. This facilitates charging powers of about 150 KW. To achieve higher charging power, energy storage systems having system voltages of 800 V are being developed, which enable charging powers of more than 250 kW. Energy storage systems with a higher system voltage can be charged within a shorter period of time, for example within five minutes to 80% of their electrical storage capacity.

Energy storage systems are most frequently contacted by means of electrical busbars. Adjacent battery cells within an energy storage system can be connected in an electrically conductive manner via at least one busbar. When such battery cells are connected to each other they form a module, wherein, depending on the electrical circuitry, an increase in the voltage or an increase in the capacity is possible. The battery cells are preferably connected in series within the energy storage assembly forming a module so that the voltage of the energy storage assembly is increased. In the case of a lithium-ion battery, the voltage of an individual battery cell is about 3.6 V, and by connecting a plurality of battery cells in series, the voltage can be substantially increased. It is also conceivable to connect a plurality of coupled modules in parallel each including battery cells connected in series. The busbars carry high electric currents, in particular, between the modules, and high voltages are applied. The busbars thus need to be reliably electrically insulated.

One of the engineering challenges with energy storage systems is the thermal runaway of battery cells. Herein, the energy stored in the battery cell is discharged suddenly and uncontrollably. When this happens, electrically conductive particles as well as hot gases are ejected as reaction products at temperatures above 1,000° C. A particularly problematic aspect is that the particle streams ejected during thermal runaway cause extreme thermal and abrasive loads. If such hot particle streams impinge on fusible surfaces, they are penetrated within a short period of time. It can thus be particularly problematic if these hot particles impinge on the busbars.

From DE 10 2022 105 700 A1, an automotive busbar is known. The automotive busbar comprises an insulating coating, wherein the insulating coating prevents the busbar from being shorted by coming into contact with external conductive surfaces within the vehicle. The insulating coating is formed of an elastomeric material and is directly molded onto the automotive busbar.

### SUMMARY

In an embodiment, the present disclosure provides a busbar, comprising an electrically conductive connector and an electrically insulating coating, wherein the connector includes at least two connection regions connected by a bridge and wherein the coating surrounds the bridge. The coating is formed of a plastic material and the coating is formed as a molded part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a perspective view of the busbar with a partially cut-away coating;

FIG. 2 schematically shows a sectional view of a further busbar with an additional body;

FIG. 3 schematically shows a sectional view of a further busbar with a thermally conductive section and a heat conductor body;

FIG. 4 schematically shows a sectional view of a further busbar with a compressible thermally conductive section and a heat conductor body;

FIG. 5 schematically shows a sectional view of the busbar of FIG. 4 with an alternatively compressed thermally conductive section;

FIG. 6 schematically shows a perspective view of an energy storage system;

FIG. 7 schematically shows a perspective view of the energy storage system of FIG. 6;

FIG. 8 schematically shows a sectional view of a further busbar with a protective element; and

FIG. 9 schematically shows a sectional view of a further busbar with protective lips.

### DETAILED DESCRIPTION

In an embodiment, the invention provides a busbar which enables improved operational safety.

The busbar according to an embodiment of the invention comprises an electrically conductive connector and an electrically insulating coating, wherein the connector includes at least two connection regions connected by a bridge, wherein the coating surrounds the bridge, wherein the coating is formed of plastic material, wherein the coating is formed as a molded part.

The coating is preferably formed of the same material throughout and in one piece. Such a busbar enables secure electric connection even in the case of malfunction and outside of the usual operating conditions. The connector can contact electric contact points and can establish an electrically conductive connection between the contact points. By providing the coating as a molded part, the outer contour of the coating, and thus within the area of the bridge, the outer contour of the busbar can be precisely defined so that it can be exactly adapted to the geometry of each respective application.

The connector can be formed of metal, in particular of copper or aluminum. The connector can be made of a metal alloy. The connector can be formed as a solid part, thus achieving a large cross-sectional area able to conduct high currents without causing excessive rises in temperature. The connector can be configured as a multi-layered structure to be particularly resistant to deformation at a light weight. The connector can also be configured as a braiding. This can improve the flexibility of the connector. The connector can be formed of metal, wherein the surface of the connector is provided with a metallic coating.

Preferably, the bridge is surrounded by the coating in such a manner that the coating completely sheaths the bridge. The coating can thus be directly arranged on the bridge and be in surface-contact with the bridge. The coating causes electric insulation of the connector so that an electrical connection can only be achieved via the connection regions. This is advantageous, in particular, for operational safety to prevent inadvertent electrically conductive connections between the busbar and other components outside of the connection regions.

Operational safety is improved if the coating is of a plastic material, wherein the plastic material has thermal properties. The plastic material is thus particularly resistant to thermal energy introduced from the outside.

The plastic material preferably has good resistance properties against abrasive particles. This enables the electric insulation of the coating to be maintained even in cases outside of the usual conditions (for example in the case of a malfunction of battery cells) so that the operational safety of the busbar is improved.

The coating can be of injection-moldable plastic. The plastic can be a thermoplastic material, a thermoset or an elastomer. Preferably, the coating is formed of an elastomer.

The coating can be formed as an injection-molded part. This enables a great number of coated busbars to be manufactured within a short period of time. Also, complex outer contours of the coating can be implemented while maintaining production numbers. Insert molding the connector with varying thicknesses or a special shape of the coating are also provided for. In this way, busbars having varying dimensions can be easily produced with high quality and at low cost.

The coating can be formed of a silicone elastomer. Silicone elastomers are excellent electric insulators and exhibit high thermal stability. In particular, the coating can be formed of a liquid silicone elastomer, preferably of a silicon compound. At high temperatures, a significant percentage of the silicone elastomers is converted to mineral substances, in particular to silicon oxides. The decomposition products thus created are not electrically conductive. This can prevent the coating from forming electrically conductive decomposition products when exposed to flames. The electrical insulation of the coating remains intact.

The coating can be provided with at least one filler. Fillers can help to further improve both the thermal and the abrasion resistance of the coating. One filler can be provided to improve the thermal resistance and a further filler can be provided to improve the abrasion resistance.

The filler can comprise an inorganic material. Preferably, the filler comprises metal oxides and/or chemical derivatives of metal oxides, in particular, hydroxides based on metal compounds of chromium, iron, aluminum, magnesium or zinc. Preferably, the chemical derivatives are provided in powder form.

Endothermically reacting compounds are preferably provided as a filler. By these means, the endothermically reacting fillers can absorb thermal energy in the case of a thermal load during a malfunction and thus directly reduce the thermal load on the coating.

The use of fillers is also provided for, which result in vitrification when thermally loaded to thus protect the coating. Furthermore, a high proportion of fillers is possible when the coating is formed of silicone elastomers without the material excessively hardening the coating. This can help to maintain flexibility of the coating even when filled with filler to a high percentage, which has advantageous results during mechanical loading, for example due to vibrations or mechanical stresses, but also with busbars that are configured to be flexible in sections.

The bridge can have a first bridge side and a second bridge side opposite the first bridge side. Herein, the bridge can have a rectangular cross-sectional configuration, and can have two long sides and two short sides, wherein one of the two long sides forms the first bridge side and wherein the other of the two long sides forms the second bridge side. The transitions between two sides can be rounded. More complex geometries are also provided, having first and second bridge sides. The first and second bridge sides can form surfaces along the busbar, wherein the surfaces are configured to be essentially planar. The surfaces can also be configured to be dome-shaped.

The coating can be thicker on the first bridge side than on the second bridge side. This can help to achieve that the coating on the first bridge side is more rugged, in particular against thermal energy or abrasive particles. The thicker coating on the first bridge side can help to absorb more thermal energy. Also, a greater number of abrasive particles is needed to penetrate the thicker coating.

The busbar can include a reinforced region associated with the first bridge side, wherein the coating is thicker in the reinforced region than in any of the other regions. Herein, the reinforced region is preferably arranged on that side of the coating which faces a potential heat or particle stream source to provide high resistance against thermal energy or abrasive particles.

The coating can include a base body and an additional body, wherein the additional body is arranged on a side of the base body facing away from the connector, and wherein the additional body is associated with the first bridge side. The additional body is preferably arranged on the outer surface of the base body facing the environment. Part of the abrasive particles impinging on the busbar in the case of a malfunction will impinge on the additional body so that a smaller number of abrasive particles will impinge on the base body.

Additionally, the additional body can be configured to be thermally insulating. In this way, the thermally insulating additional body can help to prevent thermal energy impinging on the busbar from affecting the base body. The additional body reduces the intensity of the heat or particle stress on the base body so that these measures help to further improve the operational safety. The additional body can be configured in such a manner that an insulating region is formed between the additional body and the base body. In particular, the insulating region can define an air-filled space to improve the insulating action. Furthermore, the additional body and the base body can be formed of one and the same material and in one piece. For this purpose, the base body can be formed as a lip or in the manner of a spoiler and can protrude from the base body, in particular.

A heat conductor body can be associated with the busbar, wherein the second bridge side is associated with the heat conductor body and the coating is in contact with the heat conductor body in a heat-conductive manner. The heat conductor body can be a cooler or a housing part. In the case of a malfunction and the attendant thermal load on the coating, at least part of the thermal energy can be dissipated to the heat conductor body. The thermal load on the coating is thus directly reduced.

The coating can be thermally conductive at least in part and can form, for example, a thermally conductive section. The thermal conductivity can help to better spread the thermal energy impinging on the coating, thus spreading a local concentration of thermal energy over a larger region and thereby reducing the thermal load.

The thermally conductive section can be associated with the second bridge side, wherein the thermally conductive section is preferably arranged between the connector and the heat conductor body. The thermally conductive section can extend from the connector up to the heat conductor body. The thermally conductive section can thus be arranged to extend over the entire thickness of the coating. The thermal energy can thus be better dissipated to the heat conductor body in the case of a malfunction. The thermally conductive section can be compressible and/or deformable. A fixed connection can thus be established between the thermally conductive section of the coating and the heat conductor body thus improving thermal transport. Moreover, an improved tolerance compensation of manufacturing or assembly tolerances of the components can thus be achieved. High temperatures of the connector, for example during a fast-charging operation in an energy storage system of a battery-electric vehicle, can be dissipated to the heat conductor body.

The coating can be configured in such a manner that it has an electric breakdown strength of at least 3,000 V/mm. Preferably, the coating has an electric breakdown strength of at least 4,000 V/mm. After the application of a thermal load of 1,000°° C. for a duration of 5 minutes, the electric breakdown strength of the coating can be at least 1,000 V/mm.

The connector can be connected to the coating at least partially in an adhesive manner. Such connection of the coating to the surface of the connector increases the strength of the busbar in the case of a malfunction and thus improves operational safety.

An embodiment of the invention also provides an energy storage system with improved operational safety.

Improved operational safety is achieved by an energy storage system, comprising a plurality of battery cells and at least one busbar according to an embodiment of the invention.

Preferably, the energy storage system comprises a housing. The housing can form a heat conductor body and to contact it with the busbar.

The busbar can be arranged on the battery cells in such a manner that the first bridge side of the busbar faces the battery cells. Additional measures to improve operational safety of the busbar, which can be arranged on the first bridge side, for example a reinforced region or an additional body, can thus be effectively used to protect against a potential heat or particle stream source to thus improve the operational safety of the energy storage system.

The battery cells can be coupled to form modules, wherein the modules are connected by busbars. The connection of modules thus requires only one busbar so that in the case of a malfunction a smaller number of busbars is exposed to a potential heat or particle stream source to thus improve the operational safety of the energy storage system. Moreover, a plurality of battery cells combined in a module, can then be replaced in one go.

### DETAILED DESCRIPTION OF THE INVENTION

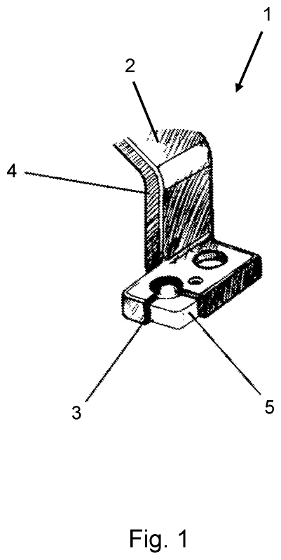

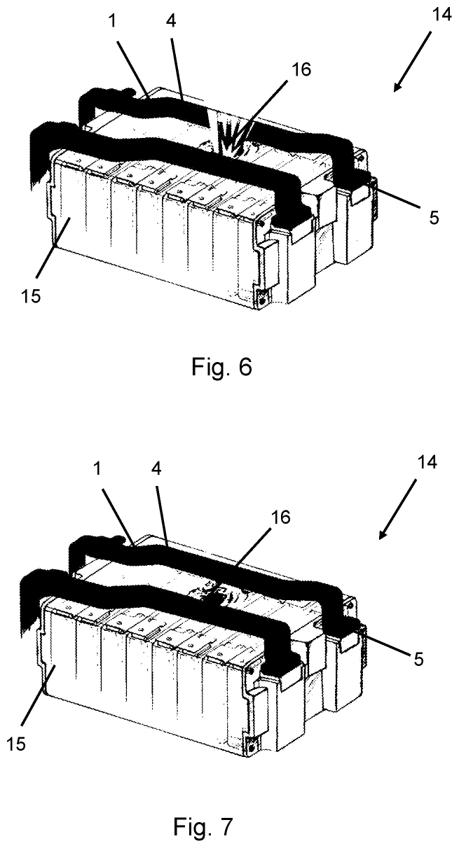

FIGS. 1 to 5, 8 and 9 show various embodiments of a busbar 1. FIGS. 6 and 7 show an energy storage system also comprising a busbar 1. Therefore, the common features of the busbars 1 will be described at first.

The above-mentioned figures include a busbar 1, comprising an electrically conductive connector 2 and an electrically insulating coating 3. The connector 2 includes at least two connection regions 5 connected by a bridge 4, wherein the coating 3 surrounds the bridge 4. The bridge 4 includes a first bridge side 6 and a second bridge side 7 opposite the first bridge side 6. The bridge 4 is configured to have a rectangular cross-section and has two long sides and two short sides, wherein one of the two long sides forms the first bridge side 6 and wherein the other of the two long sides forms the second bridge side 7. The first bridge side 6 and the second bridge side 7 form surfaces along the busbar 1, wherein the surfaces are configured to be essentially planar. In an alternative embodiment, the surfaces are configured to be dome-shaped.

The coating 3 is of one and the same material and in one piece of a plastic material, wherein the coating 3 is formed as a molded part. The coating 3 is of an injection-moldable plastic material and formed as an injection-molded part. In the present embodiment, the coating 3 is formed of a silicone elastomer.

The coating 3 is provided with fillers. Fillers improve both the temperature and the abrasion resistance of the coating 3. A first filler is provided to improve the temperature resistance and a second filler is provided to improve the abrasion resistance.

The coating 3 has an electric breakdown strength of more than 3,000 V/mm. After the application of a thermal load of 1,000° C. for a duration of 5 min, the electric breakdown strength of the coating 3 is at least 1,000 V/mm.

The connector 2 is adhesively connected to the coating 3 at least in part.

FIG. 1 shows a perspective view of a busbar 1 with the coating 3 shown partially cut away.

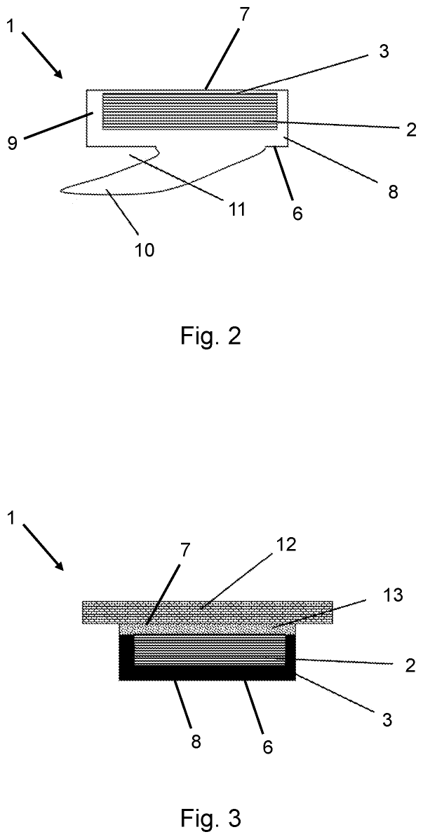

FIG. 2 shows a sectional view of a further busbar 1 with an additional body 10. The coating 3 is configured to be thicker on the first bridge side 6 than on the second bridge side 7. The busbar 1 has a reinforced region 8 associated with the first bridge side 6, wherein the ratio of a thickness of the coating 3 in the reinforced region 8 to a thickness of the coating 3 outside of the reinforced region 8 is six. The reinforced region 8 is arranged on a side of the coating 3 facing a potential heat or particle stream source.

The coating 3 has a base body 9 and an additional body 10, wherein the additional body 10 is arranged on a side of the base body 9 facing away from the connector 2 and wherein the additional body 10 is associated with the first bridge side 6. The additional body 10 is thus arranged on the outside of the base body 9. Part of the abrasive particles ejected towards the busbar 1 will impinge on the additional body 10 so that a smaller number of abrasive particles will directly impinge on the base body 9. Additionally, the additional body 10 is configured to be thermally insulating. Thermal energy impinging on the busbar 1 is thus prevented from reaching the base body 9 by the thermally insulating additional body 10. The additional body 10 is configured in such a manner that an insulating region 11 is formed between the additional body 10 and the base body 9. The insulating region 11 defines an air-filled space which improves the insulating action. The additional body 10 and the base body 9 are formed in one piece and of one and the same material. The base body 9 is configured as a lip.

FIG. 3 shows a sectional view of a further busbar 1 with a thermally conductive section and a heat conductor body 12. The busbar 1 has a heat conductor body 12 associated with it, wherein the second bridge side 7 is associated with the heat conductor body 12 and the coating 3 is in contact with the heat conductor body 12 in a heat-conductive manner. The heat conductor body 12 is configured as a heat sink, in particular as a cooler. Both in normal operation and in the case of a malfunction and the thermal load of the coating 3 associated with the malfunction, part of the thermal energy is dissipated to the heat conductor body 12.

The coating 3 is configured to be thermally conductive in sections, wherein a thermally conductive section 13 is formed. The thermal conductivity helps to better spread the thermal energy impinging on the coating 3.

The thermally conductive section 13 is associated with the second bridge side 7 so that the thermally conductive section 13 is arranged between the connector 2 and the heat conductor body 12. The thermally conductive section 13 extends from the connector 2 up to the heat conductor body 12. The thermally conductive section 13 is thus arranged to extend over the entire thickness of the coating 3.

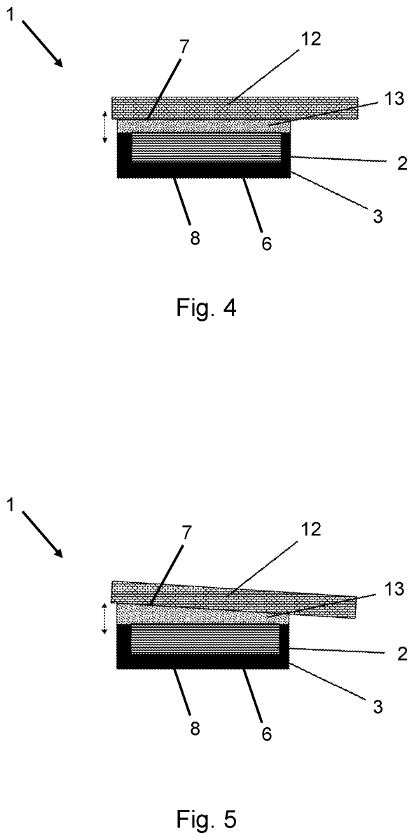

FIGS. 4 and 5 each show a sectional view of a further busbar 1 comprising a thermally conductive section 13 and a heat conductor body 12. In the present case, the thermally conductive section 13 is configured to be compressible and deformable so that a full-surface contact is established between the thermally conductive section 13 of the coating 3 and the heat conductor body 12, thus improving the heat transport. In FIG. 4, the thermally conductive section 13 is uniformly compressed so that the thermally conductive section 13 has an essentially uniform thickness. In FIG. 5, the thermally conductive section 13 is non-uniformly compressed so that the thermally conductive section 13 has a thickness that increases and decreases, respectively. In comparison with FIG. 4, the right-hand portion of the thermally conductive section 13 is more strongly compressed than the left-hand portion of the thermally conductive section 13.

FIGS. 6 and 7 each show a perspective view of an energy storage system 14.

The two figures show an energy storage system 14 comprising a plurality of battery cells 15 and two busbars 1. The energy storage system 14 comprises a housing. Each of the battery cells 15 has a vent opening 16 configured to specifically remove hot gases and/or particle streams from the interior of the battery cells 15 in the case of a malfunction. The energy storage system 14 includes two busbars 1, wherein the busbars 1 are spaced from each other. The vent opening 16 is arranged between the busbars 1.

The busbar 1 is arranged on the battery cells 15 in such a manner that the first bridge side 6 of the busbar 1 faces the battery cells 15. By these means, the above-described measures to improve operational safety of the busbar 1 which are arranged on the first bridge side 6, namely the reinforced region 8 or the additional body 10 face the vent opening 16 in the case of a malfunction and are thus opposite a potential heat or particle stream source.

FIG. 6 shows the energy storage system 14 during a malfunction. Hot gases and particle streams, part of which impinge on the busbars 1, escape from a vent opening 16. FIG. 7 shows the energy storage system 14 of FIG. 6 after the malfunction situation has cleared.

Damage can be seen in the region of the vent opening 16. The coating 3 of the busbars 1 continues to ensure sufficient electrical insulation of the busbars 1.

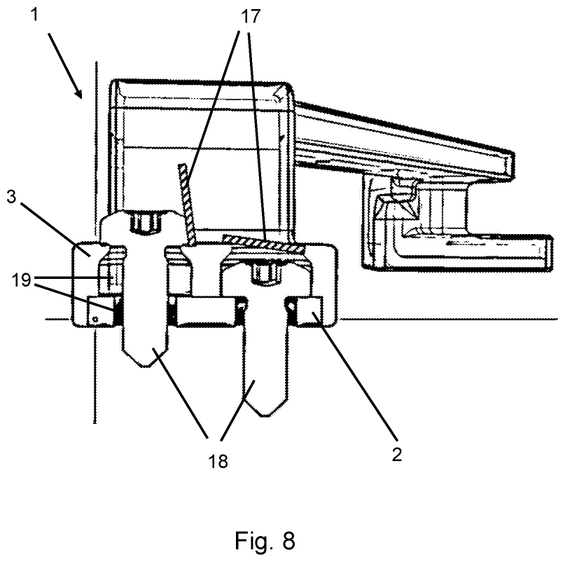

FIG. 8 shows a sectional view of a further busbar 1 with protective elements 17. The busbar 1 comprises a connection region with at least one recess 19, wherein the recess 19 extends through the connector 2 and the coating 3. The recesses 19 provided in the connector 2 and the coating 3 are arranged to be concentric with each other. A fastener 18, such as a screw, can be arranged in the recess 19. The fastener 18 can fix the busbar 1 to a further component, such as a battery cell. To do this, a portion of the fastener 18, for example the head of the screw, can have its diameter enlarged to such an extent that the enlarged portion has a larger diameter than the recess 19 in the connector 2. The fastener 18 can thus be fixed to the connector in an interlocking manner.

The diameter of the recess 19 in the coating 3 is larger than the diameter of the recess 19 in the connector 2 so that the recess 19 of the coating can accommodate the enlarged portion of the fastener 18. The coating 3 can include a protective element 17. The protective element 17 can be configured to be flexible. The recess 19 of the coating 3 can be covered by the protective element 17. By these means, the recess 19 of the coating can be covered, in particular, after the installation of the fastener 18 thus providing protection against contact of the fastener 18 to improve operational safety.

The protective element 17 can be configured as a flap. The protective element 17 can also be configured as a perforation in a planar element, which closes after the installation of the fastener 18. FIG. 8 shows two recesses 19 in the connector 2, two recesses 19, concentrically arranged therewith, in the coating 3, two fasteners 18 and two protective elements 17.

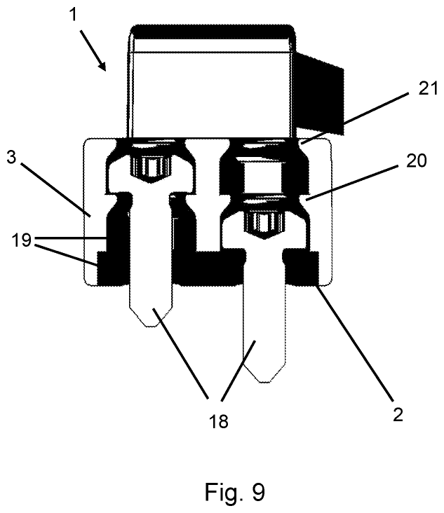

FIG. 9 shows a sectional view of a further busbar 1 with protective lips 20, 21. The busbar 1 comprises a connection region with at least one recess 19, wherein the recess 19 extends through the connector 2 and the coating 3. The recesses 19 provided in the connector 2 and the coating 3 are arranged to be concentric with each other. The two protective lips 20, 21 are formed by a circumferential collar of the coating 3. The two protective lips 20, 21 protrude into the recess 19. The protective lip 21 is arranged above the protective lip 20. A fastener 18, for example a screw, can be arranged in the recess 19. The two protective lips 20, 21 partially cover the fastener 18 so that an improved protection against contact is achieved. The protective lips 20, 21 are configured to be flexible for better ease of installation of the fasteners 18.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A busbar, comprising:
an electrically conductive connector; and
an electrically insulating coating,
wherein the connector includes at least two connection regions connected by a bridge,
wherein the coating surrounds the bridge,
wherein the coating is formed of a plastic material, and
wherein the coating is formed as a molded part.

2. The busbar according to claim 1, wherein the coating is formed of a silicone elastomer.

3. The busbar according to claim 1, wherein the coating is provided with at least one inorganic filler material.

4. The busbar according to claim 1, wherein the bridge includes a first bridge side and a second bridge side opposite the first bridge side.

5. The busbar according to claim 4, wherein the coating is thicker on the first bridge side than on the second bridge side.

6. The busbar according to claim 4, wherein the coating includes a base body and an additional body,
wherein the additional body is arranged on a side of the base body facing away from the connector, and
wherein the additional body is associated with the first bridge side.

7. The busbar according to claim 4, wherein a heat conductor body is associated with the busbar, and
wherein the second bridge side is associated with the heat conductor body and the coating is in contact with the heat conductor body in a thermally conductive manner.

8. The busbar according to claim 7, wherein the coating is thermally conductive at least in sections.

9. The busbar according to claim 8, wherein a thermally conductive section of the sections is associated with the second bridge side so that the thermally conductive section is at least partially arranged between the connector and the heat conductor body.

10. The busbar according to claim 1, wherein the coating has an electric breakdown strength of 4,000 V/mm.

11. The busbar according to claim 1, wherein the electric breakdown strength of the coating is at least 1,000 V/mm after thermal application of 1,000°° C. for a duration of 5 minutes.

12. The busbar according to claim 1, wherein the connector is at least partially adhesively connected to the coating.

13. An energy storage system, comprising a plurality of battery cells and the busbar according to claim 1.
